(19) United States
(12) Patent Application Publication
(10) Pub. No.: US 2001/0013012 A1
(43) Pub. Date: Aug. 9, 2001

(54) Portable information terminal apparatus and information provision method

(76) Inventors: Taira Hanaoka, Tokyo (JP); Akira Sakai, Tokyo (JP)

Correspondence Address: Paul J. Esatto, Jr., Scully, Scott, Murphy & Presser, 400 Garden City Plaza, Garden City, NY, 11530, US

(21) Appl. No.: 09/748,843

(22) Filed: Dec. 27, 2000

(30) Foreign Application Priority Data
Dec. 27, 1999 (JP) 369705/1999

(51) Int. Cl. G06F 17/60

(52) U.S. Cl. 705/14; 705/23; 705/34

(57) ABSTRACT

An information provision method comprises, a step of storing contents containing a moving image and being associated with an article constituted by characters or a still picture on a paper publication, which has contents locating information indicating a location of said contents and being printed within or in the vicinity of the article, in a server on a communication network, a step of reading the contents locating information on the paper publication by a portable information terminal apparatus; and a step of displaying the contents corresponding to said contents locating information on a display of said portable information terminal apparatus accessing the server and acquiring the contents based on the contents locating information.

### BACKGROUND OF THE INVENTION

The present invention relates to an information terminal apparatus, and more particularly to a portable information terminal apparatus which reads a URL written on a printed matter, obtains web contents corresponding to the read URL from a web server via a communication network such as the internet, and displays the web contents.

In general, printed matters such as newspapers or magazines have features, e.g., a viewing property, easiness of mass distribution, or facility, but types of information which can be provided are limited to characters or photographs.

On the other hand, the web contents have features, which can not be observed in the printed matters, e.g. a multimedia property capable of providing characters or still pictures as well as moving images or a quick report property, which enables rapid distribution.

In order to exploit the features of both the printed matters and the web contents, it is often the case that a URL (Uniform Resource Identifier) of a web page, which introduces products and others, appears on advertisement columns of newspapers or magazines as well as an advertisement article.

Moreover, in order to access to a corresponding web page in accordance with the URL written on a printed matter, a user generally activates a web browser and inputs the URL from a keyboard. In the great number of cases, however, the URL is a long character string, and access can be failed even if only one character in that string is wrong. The key input operation is very troublesome for the user.

There are several conventional methods for inputting the URL, which have been written on the printed matter, to the computer readily.

In a conventional method disclosed in Japanese patent application laid-open No. 204389-1997 (which will be referred to as Reference cited 1 hereinafter), a URL is bar-coded to be written on a printed matter, and the bar-coded URL is read by a wireless bar code reader for transmitting to a computer.

On the other hand, in the conventional method disclosed in Japanese patent application laid-open No. 171757-1998 (which will be referred to as Reference cited 2 hereinafter), a wireless remote controller reads an image on a printed matter, recognizes a URL in the image by the character recognition processing, and transmits the URL to a computer.

With the above-described conventional methods, a user can input a URL written on a printed matter to the computer with ease. However, the place where the user can refer to web contents corresponding to the URL is limited to a position, where a computer displaying web contents is installed. Because, the computer is a stationary type apparatus, though an apparatus for inputting a URL to a computer is portable.

### SUMMARY OF THE INVENTION

An object of the present invention to provide a portable information terminal apparatus which can readily input a URL written on a printed matter, obtain contents based on the inputted URL to be displayed and is convenient for portage.

It is another object of the present invention to provide a method for providing a moving image concerning an article written in a paper publication to a user through the portable information terminal apparatus.

A portable information terminal apparatus according to the present invention comprises; a display element; a communication element; reading means for reading information of an access destination displayed on a printed matter; a control element which connects to an access destination associated with the access destination information through the communication element based on the access destination information read by the reading means and executes a browser which receives contents from the access destination to be displayed on the display element; and an apparatus case for containing these members, a display screen of the display element being provided on the top face of the apparatus case, a reading window for the reading means being provided on the bottom face of the apparatus case. According to such a portable information terminal apparatus, since reading the access destination information written on a printed matter, communication with the access destination, and reception and display of contents by the browser can be all carried out by one portable apparatus, it is possible to readily make reference to contents associated with the access destination information written on a printed matter anywhere.

The access destination information may be a URL written on a printed matter in the form of characters or may be a URL defined and written as graphic in the form of, e.g., a bar code. In the former case, the reading means can be realized by an OCR. In the latter case, the reading means can be realized by a bar code reader. Further, the reading means may include a scanner for reading an image on a printed matter through the reading window and an extraction portion for extracting the access destination information included in an image on a printed matter read by the scanner. In this case, a memory which stores the image read by the scanner as a bookmark image may be provided. However, if a URL is printed within or in the vicinity of a given article or image and contents of the URL concern that article or image, the read image includes that article or image. Therefore, when the bookmark image is seen, it is possible to form a conjecture upon what kind of contents that URL have, which enable use as a bookmark. If multiple items of extracted access destination information exist, they may be displayed on the display element so that a user can select any information.

In addition, the communication element is preferably constituted by a radio communication element for a mobile communication service. In that case, the portable information terminal element may desirably include means for establishing automatic connection to an access point of a predetermined provider by using a telephone number of a preset access point, a user identifier and a password so that automatic connection to a specific provider is enabled. Moreover, in order to save the fee, it is desirable to provide means for automatically disconnecting a radio communication line when reading contents by the browser is completed.

Contents to be provided may be constituted by a moving image or both a moving image and sounds in order to exploit the multimedia property which can not be provided from a printed matter such as a newspaper. Contents may include other information such as advertisement information.

An information provision method using the above-described portable information terminal apparatus according to the present invention comprises the steps of: registering contents including a moving image to a WWW server in correspondence with a URL; providing to user a paper publication having the URL of the contents concerning an article constituted by characters or a still image printed thereon within an article or in the vicinity of that article; urging a user to read and transmit the URL printed on the paper publication by utilizing the portable information terminal apparatus; transmitting the contents associated with the URL sent from the portable information terminal apparatus to the WWW server to be displayed on a display element of the portable information terminal apparatus. According to such an information provision method, increase in a quantity of information and improvement in quality are possible which can not be attained by a paper publication alone.

### BRIEF DESCRIPTION OF THE DRAWINGS

These and other objects, features and advantages of the invention will become more apparent from the following detailed description when taken in conjunction with the accompanying drawings, in which:

FIG. 1 is an exterior perspective view of an information terminal apparatus according to an embodiment of the present invention;

FIG. 2 is an exterior perspective view of the information terminal apparatus according to the embodiment of the present invention, showing from the bottom Face;

FIG. 3 is a block diagram showing an example of the hardware structure of the information terminal apparatus according to the embodiment of the present invention;

FIG. 4 is a view showing a structural example of a scanner and an installation position thereof;

FIG. 5 is a flowchart showing a processing example in the information terminal apparatus according to the embodiment of the present invention;

FIG. 6 is a flowchart showing a processing example of the information terminal apparatus when a bookmark operation item is selected;

FIG. 7 is a flowchart showing a processing example of the information terminal apparatus when a contents reproduction item is selected;

FIG. 8 is a block diagram showing an example of an information provision system when the information terminal apparatus according to the present invention is utilized;

FIG. 9 is a block diagram showing a structural example of a server when contents including advertisement information are included;

FIGS. 10(a) to 10(d) are views showing a content example of an advertisement control information table;

FIG. 11 is a view showing a content example of a record associated with an advertiser in an accounting file;

FIGS. 12(a) to 12(d) are views showing a content example of an accounting control information file;

FIG. 13 is a flowchart showing a processing example of a contents server;

FIG. 14 is a flowchart showing a processing example of an accounting server; and

FIG. 15 is a flowchart showing another processing example of an accounting server.

### DESCRIPTION OF THE PREFERRED EMBODIMENT

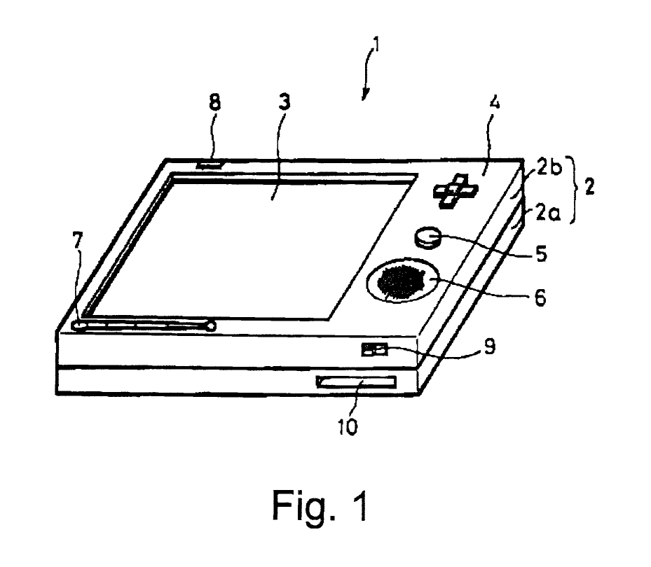

Referring to FIG. 1, an information terminal apparatus 1 according to an embodiment of the present invention has an apparatus case 2 including a lower case 2a and an upper case 2b fitted to the lower case 2a. The apparatus case 2 has a size such that a person can grab with one hand, and on the top face of the upper case 2b are provided a display 3, an operation switch 4, an execution button 5, a speaker 6, and an antenna 7. The display 3 comprises, e.g., an LCD, and the display screen takes up more than a half of the entire area of the top face of the upper case 2b. The operation switch 4 is a cross key switch having four direction indication portions. When any of the direction indication portions is selected and pressed by a user, a cursor (not shown) on the display 3 can be moved in the vertical and horizontal directions indicated by the direction indication portions. The execution button 5 is a button, which activates an operation indicated by the cursor and selected by the user. The antenna 7 can be bent at its base portion. When the antenna 7 is not used, it can be folded down along the upper case 2b as shown in FIG. 1. When the antenna 7 is used, it can be set upright.

A reading start button 8 and a power supply switch 9 are provided to the upper case 2b. The reading start button 8 is a button operated when starting reading a URL on a printed matter. For example, this button is provided at a position on which an index finger is placed when a thumb is put on a side surface of the upper case 2b below the antenna 7 while a middle finger and an annular finger are put on a side surface of the upper case 2b on the opposed side and the apparatus case 2 is held by the right hand. Further, a slot 10 for a PC memory card is provided to the lower case 2a.

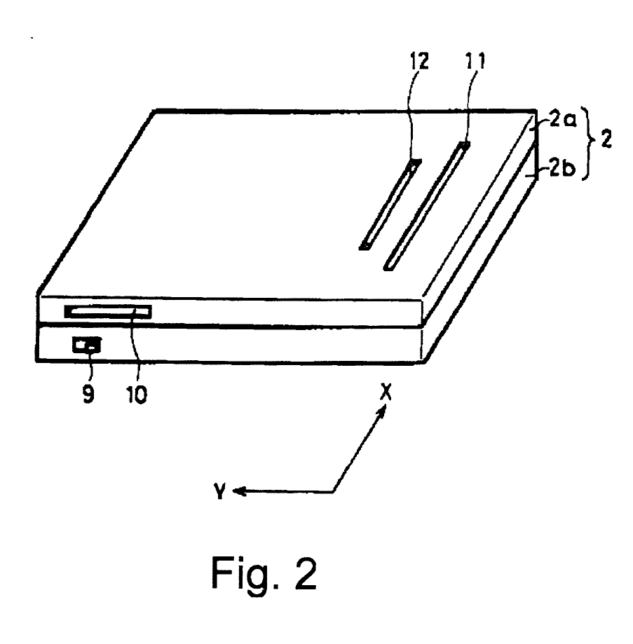

Referring to FIG. 2, a slit type reading window 11, which extends in a direction (the X direction in the drawing) vertical to the longitudinal direction of the apparatus 1 (the Y direction in the drawing), is provided on the bottom surface of the substantially flat lower case 2a. For example, a piece of transparent glass is put in the reading window 11. An image including a URL on a printed matter is two-dimensionally scanned in both the X direction and the Y direction through this reading window 11. Scanning in the X direction (main scanning) is electrically carried out, and scanning (sub scanning) in the Y direction is performed by moving the information terminal apparatus 1 itself in the Y direction. A distance measurement roller 12 for detecting an amount of movement in the Y direction is, therefore, included, and a part of the circumferential surface of the roller 12 protrudes from the bottom surface of the lower case 2a.

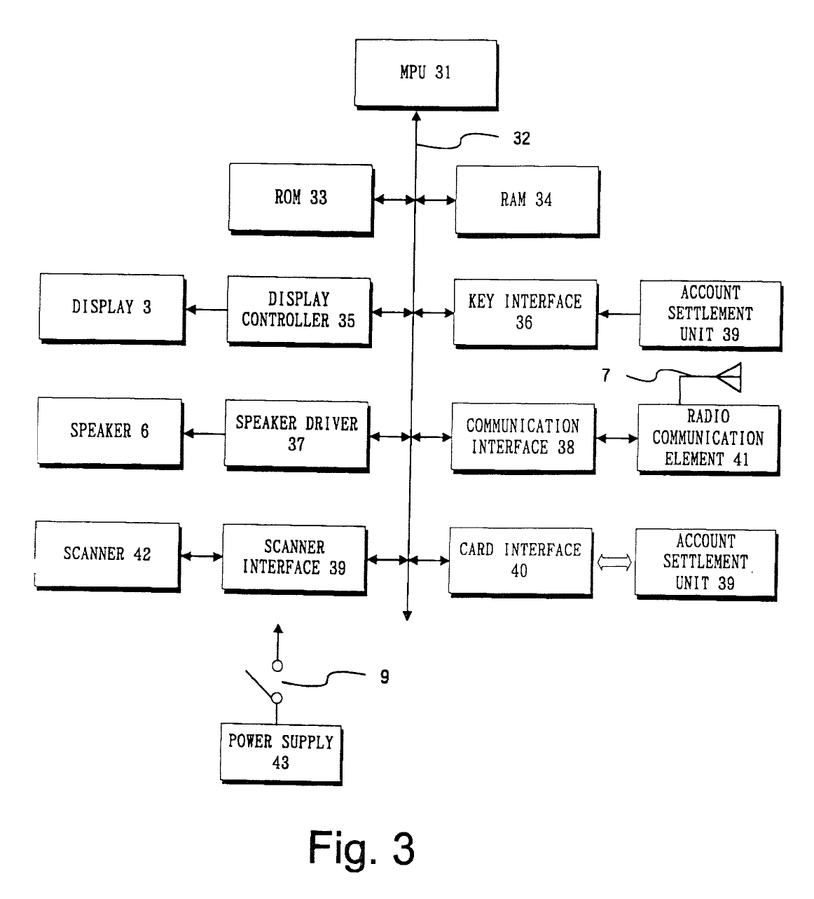

Referring to FIG. 3, in the apparatus case 2 includes: an MPU 31, a ROM 33, a RAM 34, a display controller 35, a key interface 36, a speaker driver 37, a communication interface 38, a scanner interface 39, and a card interface 40 which are connected to a bus 32 respectively; a radio communication element 41 connected to the communication interface 38; a scanner 42 connected to the scanner interface 39; and a power supply 43 comprising a primary battery or a secondary battery for supplying power to each element in the apparatus 1 through a power supply switch 9. The display controller 35 is connected to the display 3; the speaker driver 37, to the speaker 6; and the radio communication element 41, to the antenna 7. The key interface 36 is connected to an operation portion 44 including the operation switch 4, the execution button 5, and the reading start button 8. Further, the card interface 40 is connected to a PC memory card 45 inserted into the slot 10.

The MPU 31 controls the entire information terminal apparatus 1, and various kinds of programs or control data executed by the MPU 31 are stored in the ROM 33. One of the programs stored in the ROM 33 is a web browser. A moving picture reproduction function or a sound reproduction function is previously plugged in the browser. As typical control data, there is provider connection information. The provider connection information includes a telephone number of an access point, a user identifier, and a password.

The RAM 34 temporarily stores an image read by the scanner 42 or an image acquired through a communication network such as the Internet, or is used as various work areas. The display controller 35 controls display of an image and the like directed by the MPU 31 on the display 3. The key interface 36 informs the MPU 31 of key-input from the operation portion 44 by interruption and the like. The speaker driver 37 converts a digital sound signal into an analog sound signal, and drives the speaker 6.

The communication interface 38 is an interface between the MPU 31 and the radio communication element 41. The radio communication element 41 is designed so as to be adapted to a specific mobile communication service. This element 41 is used when the information terminal apparatus 1 accesses to an access point of an Internet Service Provider. As a mobile communication system, for example, a digital cellular phone system is utilized.

The card interface 40 is compliant to PCMCIA (Personal Computer Memory Card International Association) standard and in charge of the interface between the PC memory card 45 and the MPU 31. Acquired contents and the like are stored in the PC memory card 45.

The scanner interface 39 is an interface between the scanner 42 and the MPU 31, and in charge of processing such as activating the scanner 42 in accordance with an instruction from the MPU 31 or converting image data read by the scanner 42 into a digital signal to be stored in a predetermined area in the RAM 34.

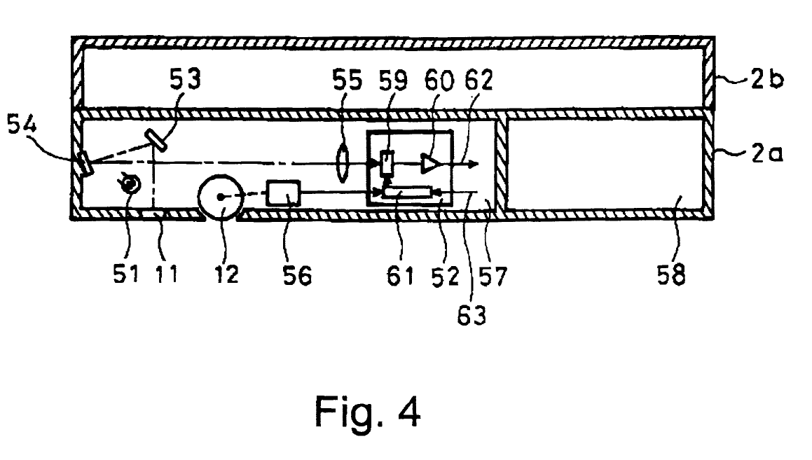

Referring to FIG. 4, the scanner 42 includes: a lamp 51 for irradiating a surface to be read on a printed matter through the reading window 11; a photoelectric transfer portion 52; mirrors 53 and 54, and a lens 55 for inflecting a reflected light ray from the surface to be read and leading the light ray to the photoelectric transfer portion 52; and an encoder 56 for detecting an amount of movement in the Y direction from a rotational angle of the distance measurement roller 12 to be outputted to the photoelectric transfer portion 52. The scanner 42 is arranged in a chamber 57 of the lower case 2a. It is to be noted that a chamber 58 accommodating therein a slot 10 for the PC card is also provided in the lower case 2b and the upper case 2b accommodates other necessary components such as the display element but the illustration is omitted. The photoelectric transfer portion 52 includes: a one-dimensional image sensor 59 such as a CCD sensor; an amplifier 60 for amplifying an output of the sensor 59 to be outputted to the scanner interface 39 through a signal line 62; and a control portion 61 for controlling main scanning of the one-dimensional image sensor 59 and controlling sub scanning in the Y direction in accordance with an output from the encoder 56. The control portion 61 is connected to the scanner interface 39 through the signal line 63. Although not illustrated, the control portion 61 is also connected to the lamp 51 in order to control on/off of the lamp 51.

The operation of the information terminal apparatus 1 according to this embodiment will now be described.

When the power supply switch 9 is turned on, power is supplied from the built-in power supply 43 to respective elements, and the information terminal apparatus 1 enters the operable state.

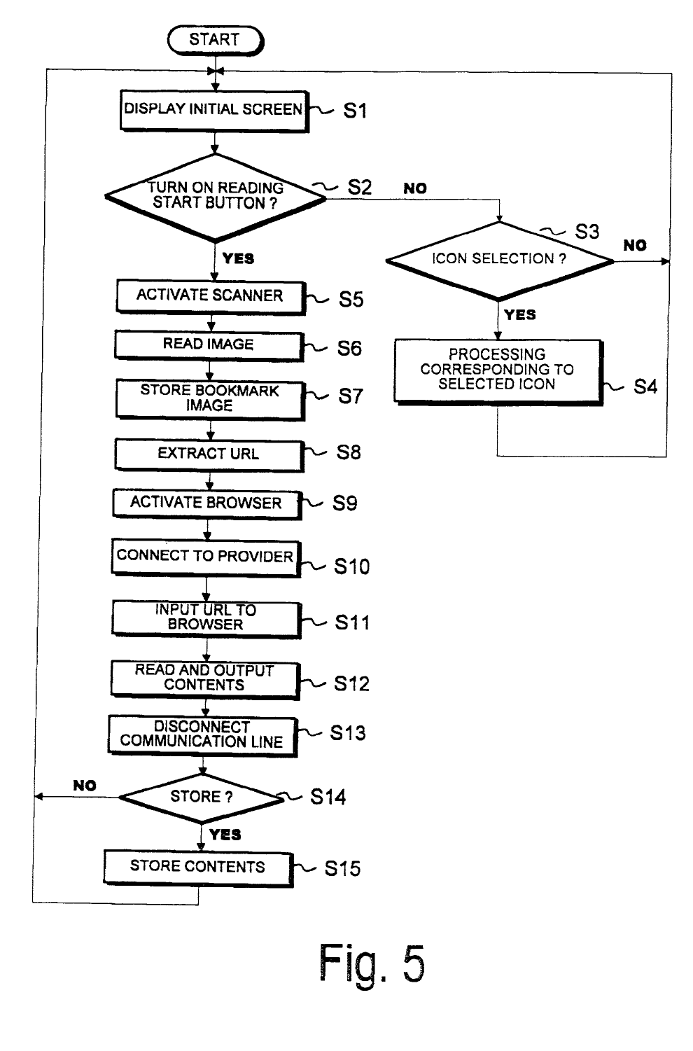

When the power supply is turned on, the MPU 31 starts the processing shown in FIG. 5. The MPU 31 first displays an initial screen on the display 3 through the display controller 35 (Step S1). Icons are displayed on the initial screen. The MPU 31 determines whether the reading start button 8 is turned on (Step S2).

In case that the reading start button 8 is not turned on, the MPU 31 determines whether the icon on the initial screen is selected and the execution button 5 is turned on (Step S3). When any icon is selected by the operation switch 4 and the execution button 5 is turned on (YES in Step S3), the MPU 31 executes a processing associated with the selected icon (Step S4). This processing will be described later.

On the other hand, when a user puts the reading window 11 of the information reading apparatus 1 on an area of a printed matter where a URL is written and turns on the reading start button 8 (YES in Step S2), the MPU 31 activates the scanner 42 through the scanner interface 39 (Step S5). The control portion 61 of the activated scanner 42 turns on the lamp 51 and controls scanning of an image on a printed matter which is to be image-formed on the one-dimensional image sensor 59 to read the image (Step S6). Reading of the image is stopped when the reading start button 8 is turned off or an amount of movement in the Y direction detected by the encoder 56 reaches a predetermined value. The image read by the scanner 42 is stored as a bookmark image in a predetermined area on the RAM by the scanner interface 39 (Step S7).

Upon completion of the reading the image and the storage processing of that image, the MPU 31 executes a URL extraction program stored in the ROM 33, and extracts a URL from the bookmark image stored in the RAM 34 (Step S8). In order to extract the URL by the URL extraction program, the bookmark image is first subjected to character recognition to extract all characters as similar to the character recognition processing in the OCR. A character string “http:” is then retrieved from a result of character recognition and characters starting from “http:” to the next null are extracted as a URL.

When the URL extraction processing is completed, the MPU 31 activates the browser stored in the ROM 33 (Step S9). When the browser is activated, the screen on the display 3 is changed from the initial screen to the browser screen. The MPU 31 then reads a Internet Service Provider connection information (a telephone number of an access point, a user identification name, and a password) stored in the ROM 33 and calls to the access point of the provider from the radio communication element 41 via the communication interface 38. When connection is established, the user identification name and the password are transmitted to connect to the provider (Step S10). The extracted URL is inputted to the browser (Step S11). As a result, the browser transmits a request for acquiring contents whose URL is designated to the provider through the radio communication element 41 and reads the contents transmitted from the corresponding web server on the communication network in accordance with transmission of the request. The document or image contents are displayed on the display 3 through the display controller 35, and the sound contents are outputted from the speaker 6 through the speaker driver 37 (Step S12).

Upon completion of reading the contents from the web server by the browser, the MPU 31 immediately disconnects the communication line with the provider in order to save a communication charge (Step S13). Even if the communication line is disconnected, the browser repeatedly outputs the read contents for a predetermined period of time.

A user selects whether or not he/she saves this information (Step S14). When a user selects a save instruction on the browser screen by the operation switch 4 and presses the execution button 5 in the predetermined period (YES in Step S14), the current contents are stored in the PC memory card 45 through the card interface 40 (Step S15). A name prepared by the web server is automatically given to the contents to be stored. The browser terminates its processing after the predetermined period of time and the screen on the display 3 returns to the initial screen.

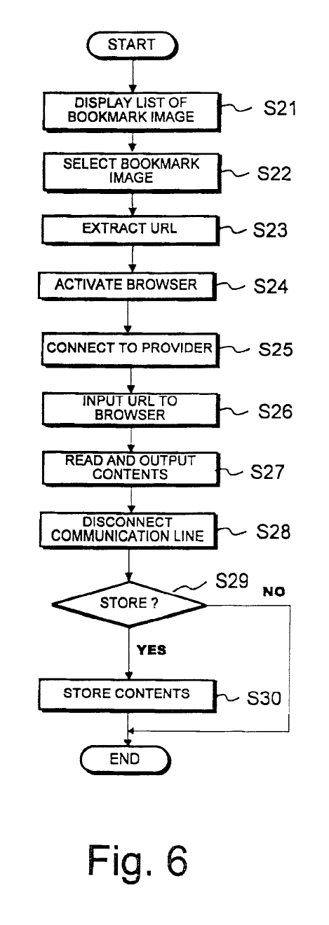

There are a bookmark icon and a contents reproduction icon on the initial screen. Referring to FIG. 6, when the bookmark icon is selected, the MPU 31 displays a list of bookmark images (for example, images obtained by minimizing respective bookmark images) stored in the RAM 34 so far on the display 3 (Step S21) and urges a user to select any image (Step S22). Selection of the bookmark image can be performed by manipulating the operation switch 4 to position the cursor on a bookmark image to be selected and pressing the execution button 5. The processing after one bookmark image is selected is similar to that of the steps S8 to S15 illustrated in FIG. 5 (Step S23 to Step S30). That is, the MPU 31 extracts the URL from the selected bookmark image (Step S23), activates the browser (Step S24), connects to the provider (Step S25), and inputs the extracted URL to the browser (Step S26). Further, the browser reads the corresponding contents from the web server via the communication network (Step S27) and stores them in the PC memory card 45 upon receiving a storage instruction from a user (Step S29, Step S30). Additionally, upon completion of reading the contents, the MPU 31 immediately disconnects the line (Step S28).

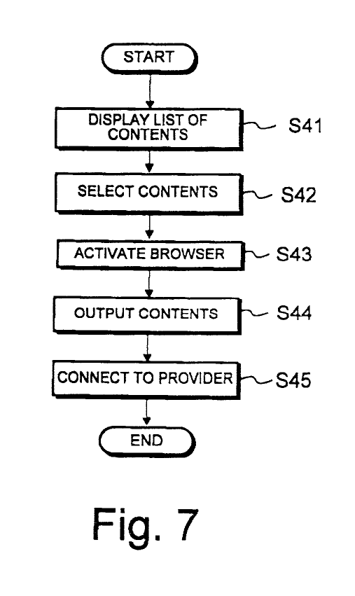

Referring to FIG. 7, when the content reproduction icon is selected, the MPU 31 displays a list of contents (for example, a list of names given to the respective contents) stored in the PC memory card 45 on the display 3 (Step S41) and urges a user to select any of the contents (Step S42). Selection of the contents can be executed by manipulating the operation switch 4 to position the cursor on the contents to be selected and pressing the execution button 5. When one of the contents is selected, the MPU 31 activates the browser (Step S43) and causes the browser to display the selected contents (Step S44).

Although this embodiment of the information terminal apparatus has been described above, the information terminal apparatus according to the present invention is not restricted to the above embodiment, and various kinds of addition or modification such as described below are possible.

In the above description, although the URL is represented by characters on a printed matter, it may be represented by a one-dimensional bar code, a two-dimensional bar code, or any other graphic symbol. When it is represented by a bar code and the like, a predetermined graphic symbol portion such as a bar code is extracted from a bookmark image and the URL is detected from that graphic symbol in the step S8 of FIG. 5. Further, a bar code reader may substitute for the scanner 42. A bar code or a graphic symbol in which the URL is embedded may include title information of that URL. In this case, the URL and the title information can be clearly distinguished from each other by a predetermined sign and the like and, embedded in a bar code. When the title information is included, the title information is extracted together with the URL in the step S8 of FIG. 5. The extracted title information is utilized as an index of a bookmark image stored in the step S7 of FIG. 5, for example.

Although only one URL extracted from the image read from a printed matter is assumed, if a plurality of URLs are included in the image, all the URLs may be extracted and the extracted URLs may be displayed on the display element 3 so that a user can select any URL. If the title information is included as described above, the title information may be displayed to be selected.

The processing of the step S23, in cases where the bookmark image and the URL extracted from that image are associated with each other to be stored in the RAM 34 and the bookmark icon is selected, may be substituted by the processing for reading from the RAM 34 the URL stored in association with the selected bookmark image.

Although the manual type scanner 42 is used, it is also possible to use a fixed type scanner in which the reading window 11 is widely assured in the Y direction so that optical systems (51, 53, 54, and 55 in FIG. 4) are mechanically moved in the Y direction.

Although connection to the provider is achieved by radio using the mobile communication system, a wire telephone may be used. In this case, however, use of such a telephone is limited in a range where a telephone cable can be extended.

Next, an information provision system exploiting the information terminal apparatus according to the present invention will be described.

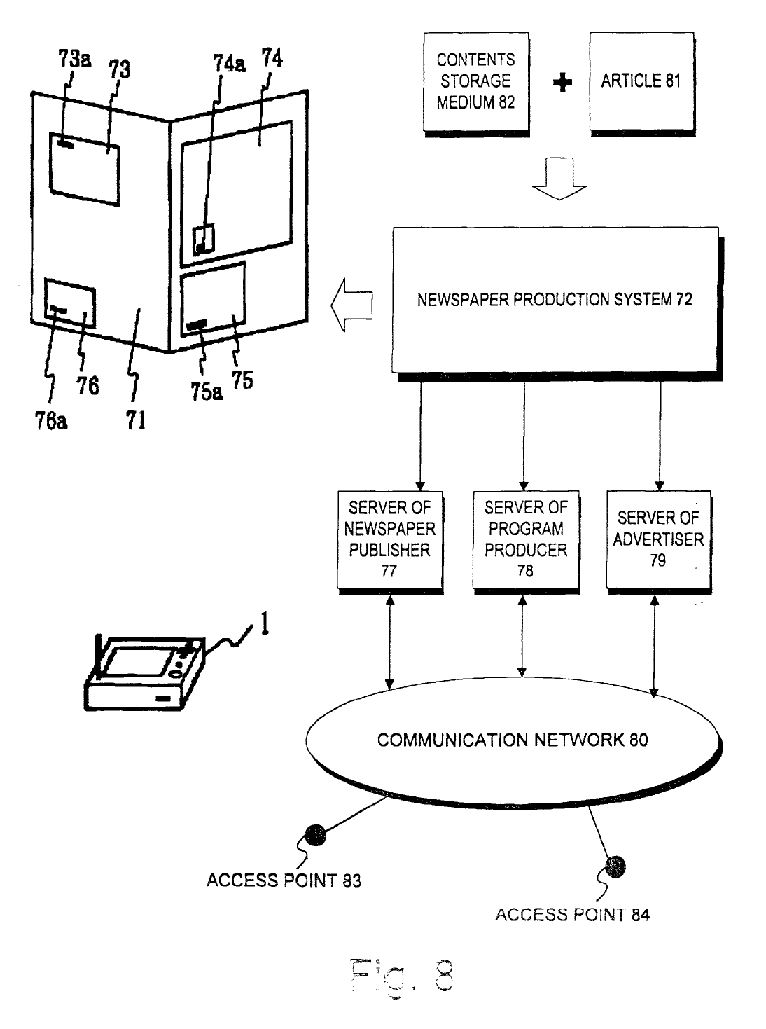

Referring to FIG. 8, a newspaper 71 is a general newspaper, a sport paper or a trade paper which is produced by a newspaper production system 72 in a newspaper publisher and sold at station kiosks or delivered to each subscriber's home. On the newspaper 71 are printed various kinds of articles, for example, an article 73 such as a general article or a sport article consisting of characters or photographs, an article 74 of a TV program column, an article 75 of an advertisement column, or an article 76 of a weather forecast column. URLs 73a, 74a, 75a, and 76a are defined as characters or graphics such as a bar code and printed in each article.

Servers 77, 78, and 79 store contents and are connected to a communication network 80 such as the Internet. The newspaper production system 72 terminates the operation for registering the contents associated with respective URLs 73a to 76a written on the newspaper 71 to the servers 77 to 79 and the operation for confirming the registered contents at least by the time the newspaper 71 is delivered to each subscriber. In this embodiment, the servers include the server 77 managed and operated by a newspaper publisher, the server 78 managed and operated by a program producer, and the server 79 managed and operated by an advertiser. The contents, which correspond to the URL 75a printed in the article 75 of the advertisement column, are registered in the server 79 of the advertiser. The contents, which correspond to the URL 74a printed in the article 74 for introducing a given program in the TV program column, are registered in the server 78 of the program producer. The contents, which correspond to the URL 73a printed in the article 73 such as a general article or a sport article, are registered in the server 77 of the newspaper publisher issuing this newspaper 71.

The newspaper production system 72 and the servers 77 to 79 are connected online. The contents are registered in the servers 77 to 79 from the newspaper system 72 based on a contents storage medium 82 handed together with an original 81 of articles 73 to 76 placed on the newspaper 71. Registration of the contents to the servers 78 and 79 which are not managed and operated by the newspaper publisher 77 is also carried out from the newspaper production system 72 because the newspaper publisher itself must bear a responsibility to the contents associated with the URL printed on the newspaper 71 issued from that publisher. If such a responsibility is not necessary, the program producer and the advertiser are of course in charge of the operation for registering the contents to the servers 78 and 79.

There are some access points managed and operated by a specific provider on the communication network 80, a part of readers who purchased the newspaper 71 has the information terminal apparatus 1 according to the present invention. If a reader reads pages of the newspaper 71 and a URL is written in an interesting article, he/she can make reference to contents of the URL by using the information terminal apparatus 1.

Since the contents associated with the URL 73a to 76a written in the respective articles 73 to 76 exploit the multimedia property which can not be provided by the newspaper 71 which is a printed matter, the contents should be preferably constituted by a moving image or both a moving image and sounds associated with that article.

For example, in a case of an article 73 consisting of characters, preparing contents including a moving image obtained by actually picturizing a scene represented by a sentence or both a moving image and sounds in association with the URL 73a can be useful for understanding of the article. Further, if the article 73 is constituted by a still picture, the contents can be:

(1) a moving image associated with that still picture;

(2) a moving image following to that still picture;

(3) a moving image followed by that still picture; and

(4) a moving image including that still picture.

Sounds can be of course included in the contents. If the article 73 is a picture of a moment that a given popular professional baseball player hit a homerun, a moving image starting from throwing a ball by a pitcher to entering of the ball into a stand can be provided by this type of contents.

As contents associated with the URL 76a written in the article 76 of a weather forecast column, contents which show weather charts with time in the form of moving pictures can be considered. In this case, a reader can obtain the latest weather chart by appropriately updating the contents on the server 77. Further, as the contents associated with the URL 174a written in an article 74 introducing a given program in the TV program column, there can be the contents including a moving image showing a scene of that program and sounds. In addition, as the contents associated with the URL 75a written in the advertisement column 75, if the advertisement is one for a given movie, a moving image or sound data including one scene or comments of that movie can be used. Moreover, in case of the advertisement of a car, a moving image showing a scene of that car traveling can be used. Additionally, a moving image of a music promotion can be provided.

Advertisement information can be included in the contents. As a method for adding the advertisement information, there are following conformations.

(1) A still picture or a moving image for advertisement is previously superimposed on contents of the moving image to be distributed.

(2) A still picture or a moving image for advertisement is added at the head, midpoint or tail of contents of the moving image to be distributed in the web server. The contents having such a picture or image added thereto in advance may be of course stored.

(3) A URL of the contents for advertisement is added to be transmitted by the web server. In such a case, the information terminal apparatus 1 may have a function for storing received URL information, a function for urging a reader to appropriately select that URL, and a function for having access based on the selected URL and obtaining advertisement information to be displayed. The advertisement information may be preferably a moving image. A plurality of items of URL information as the advertisement information may be transmitted.

The advertisement charge that the newspaper publisher receives can be differentiated in accordance with types or contents of an article to which the advertisement information is added. Further, it can be differentiated in accordance with selection of (1) to (3) described above. In case of adding the advertisement information to the contents, the allocation time for the advertisement information to be distributed may be changed with time. That is, in regard to a given article, the advertisement of a certain company is added in the morning, and the advertisement of another company is added in the afternoon. In such a case, the advertisement charge can be differentiated in accordance with each time zone in which the advertisement is added. Further, since it is generally possible to grasp the access frequency with respect to the contents from the access log in the web server, the advertisement charge can be determined in accordance with the access frequency. Moreover, the advertisement information to be added can be changed in accordance with a position or area where a reader (information terminal apparatus 1) exists. The position of the information apparatus 1 can be detected by a GPS or a micro cell network. The WWW server obtains the position of the terminal and adds the advertisement information according to the position.

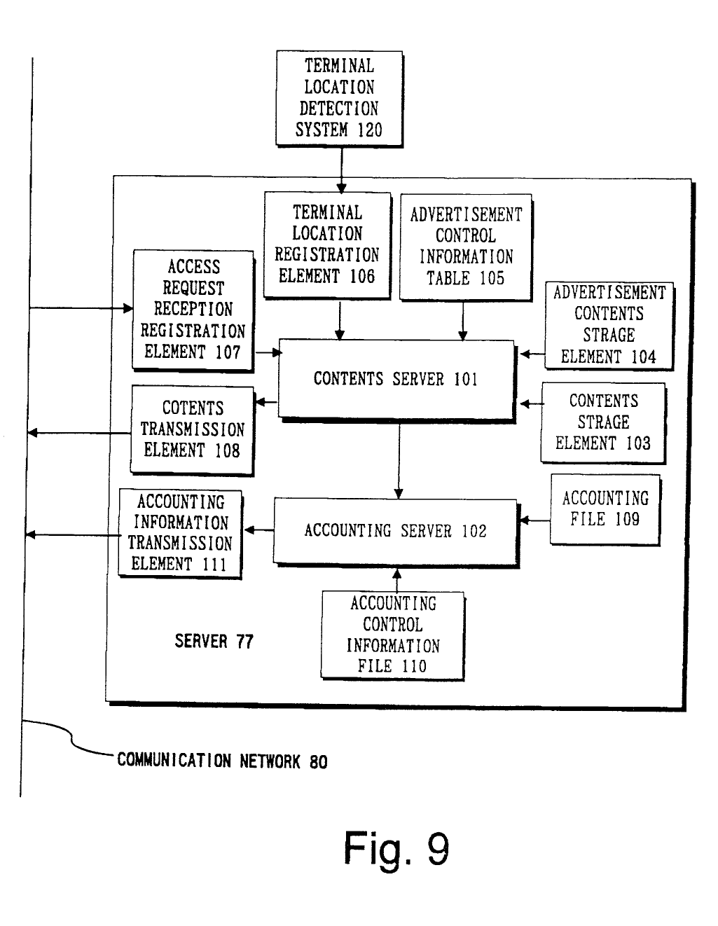

Referring to FIG. 9, the server 77 in case of providing contents including advertisement information includes a contents server 101, an accounting server 102, a contents storage element 103 connected to the contents server 101, an advertisement contents storage element 104, an advertisement control information table 105, a terminal position registration element 106, an access request reception element 107, a contents transmission element 108, an accounting file 109 connected to the accounting server 102, an accounting control information file 110, and an accounting information transmission element 111.

The contents storage element 103 stores contents corresponding to the URL 73a added to the article 73. The advertisement contents storage element 104 stores advertisement contents added to the article 73. In case of using the advertisement conformation (1) among the advertisement conformations (1) to (3) described above, advertisement contents such as a still picture or a moving image for advertisement are previously superimposed on the contents themselves in the contents storage portion 103. In case of the advertisement conformation (2) by which the advertisement contents are added at the head, midpoint or tail of the contents to be distributed by the server 77, and the advertisement conformation (3) by which the URL for the advertisement contents is added to be transmitted by the server 77, the advertisement contents are stored in the advertisement contents storage portion 104 in association with the URL.

The terminal position registration element 106 stores terminal position information reported from an external terminal position detection system 120 which grasps the latest position of the information terminal apparatus 1 by using, e.g., a micro cell network. The terminal position registration element 106 holds a pair of a terminal identifier (for example, a user identifier transmitted by the radio communication element 41 at calling) which uniquely identifies the information terminal apparatus 1 and position information.

The access request reception element 107 receives an access request designated to the server 77 from the communication network 80 and informs the contents server 101 of reception. The access request includes the URL of the contents to be accessed and the terminal identifier. The contents transmission element 108 transmits the contents received from the contents server 101 to a designated apparatus 1 through the communication network 80.

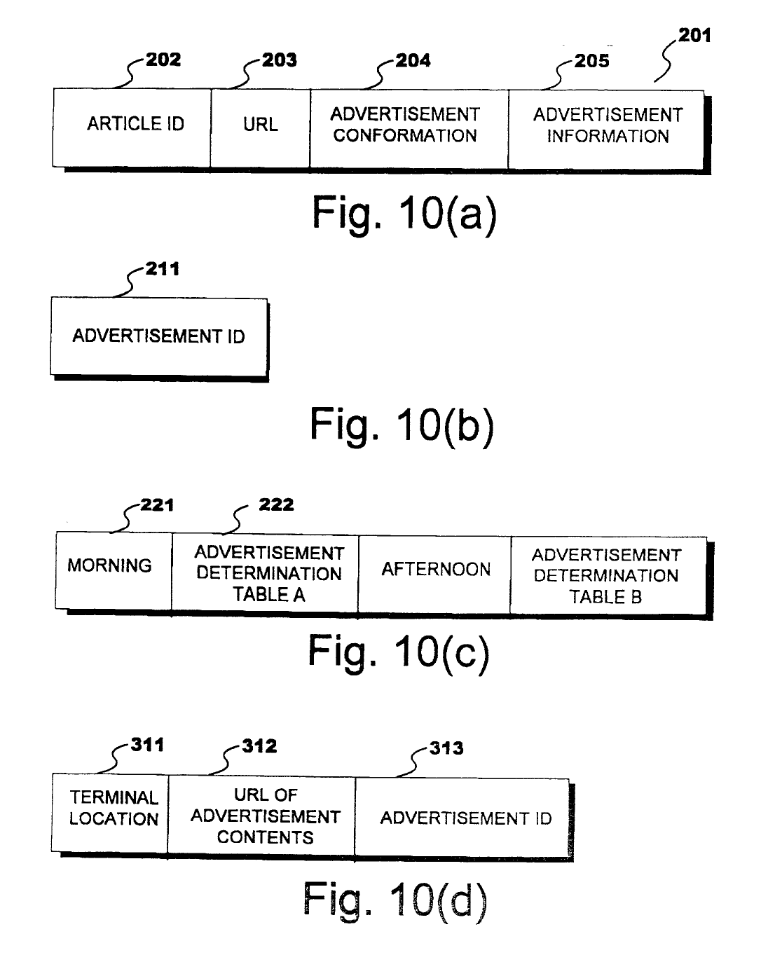

The advertisement control information table 105 holds various kinds of control information concerning the advertisement to be provided. Referring to FIG. 10(a), the advertisement control information table 105 includes a set of entries 201 relating to the article 73 by the one-to-one correspondence. One entry 201 corresponding to a given article includes an article ID 202 which uniquely identifies the article, a URL 203 added in the article, an advertisement conformation 204, and advertisement information 205. The advertisement conformation 204 represents any advertisement conformation of (1) to (3) described above.

The advertisement information 25 differs depending on the advertisement conformation (1), and the remaining advertisement conformations (2) and (3). Referring to FIG. 10(b), in case of the advertisement conformation (1), an advertisement ID 211 which uniquely identifies the superimposed advertisement is set in the advertisement information 205. Referring to FIG. 10(c), in case of the advertisement conformations (2) and (3), at least one pair of time zone information 221 and a advertisement determination table name 222 is set. In the illustrative example FIG. 10(C), the time zone is divided into the morning and the afternoon, and advertisement determination table names A and B are set to them, respectively. Referring to FIG. 10(d), the advertisement determination table A is a table in which a set of a terminal position 311, a URL 312 of advertisement contents in the morning and an advertisement ID 313 is previously registered in accordance with a predetermined terminal position. The advertisement determination table B is basically the same as the advertisement determination table A for the morning except that a URL of advertisement contents in the afternoon is registered.

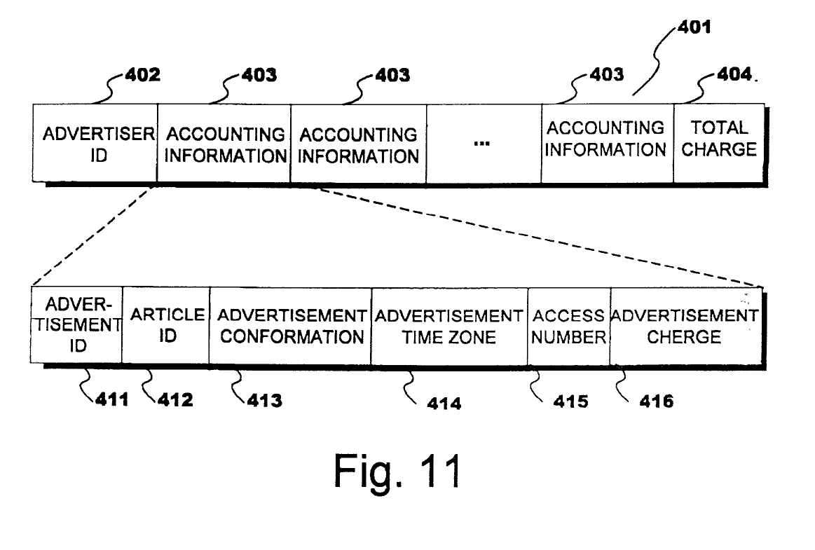

The accounting file 109 connected to the accounting server 102 holds accounting information relative to the advertiser and stores records for respective advertisers. Referring to FIG. 11, one record 401 associated with a given advertiser includes an advertiser ID 402 which uniquely identifies the advertiser, accounting information 403 for each advertisement given out by the advertiser, and a total advertisement charge 404 with respect to the advertiser. Further, one item of accounting information 403 corresponding to a given advertisement includes an ID 411 for that advertisement, an ID 412 of an article in which the advertisement is published, the advertisement conformation 413, a time zone 414 in which the advertisement is given out, a number of times of accesses 415, and an advertisement charge 416 with respect to the advertisement.

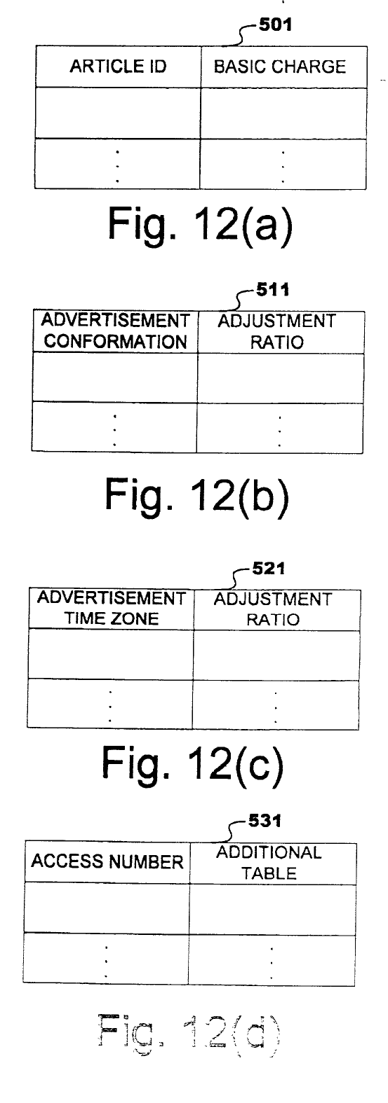

The accounting control information file 110 is a file for storing a charge table used by the accounting server 102 for calculating the advertisement charge. Referring to FIGS. 12(a) to (d), the accounting control information file 110 stores four types of charge tables, i.e., an article basic charge table 501 shown in FIG. 12(a), an advertisement conformation charge table 511 shown in FIG. 12(b), an advertisement time zone charge table 521 shown in FIG. 12(c), and an access number charge table 531 shown in FIG. 12(d).

The article basic charge table 501 holds the basic charge for each article ID. The basic charge is differentiated in accordance with types or contents of articles. The advertisement conformation charge table 511 holds an adjustment ratio of the advertisement charge for each advertisement conformation. For example, the advertisement conformation charge table 511 holds the adjustment ratio of 100% for the advertisement conformation (1), 70% for the advertisement conformation (2), and 30% for the advertisement conformation (3). The advertisement time zone charge table 521 holds the adjustment ratio of the advertisement charge for each advertisement time zone. For example, the advertisement time zone charge table 521 holds the adjustment ratio of 80% for the morning and 100% for the afternoon. The access number charge table 531 holds the additional charge for each access number. For example, the access number charge table 531 holds contents, e.g., 0% additional charge if the access number is less than a given value X, 20% of the basic charge if the access number is not less than X and less than Y, and 30% of the basic charge if the access number is not less than Y.

Next, a processing of the contents server 101 which provides the advertisement information included in the contents, and a processing of the accounting server 102 will be described.

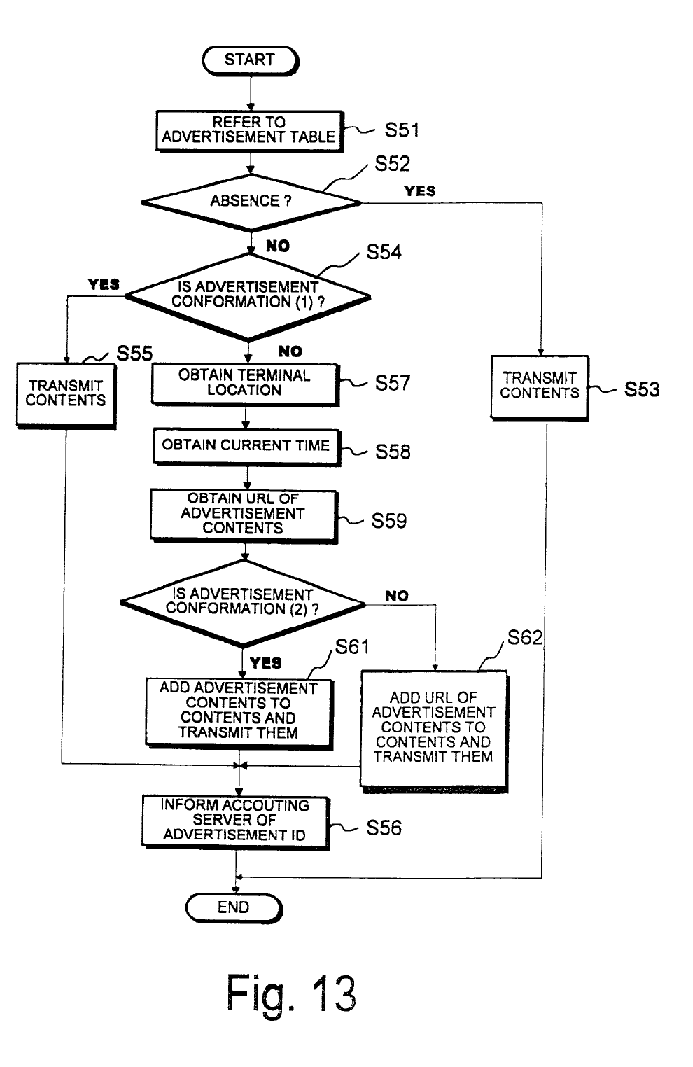

Referring to FIG. 13, upon receiving an access request from the communication network 80 via the access request reception element 107, the contents server 101 starts the processing shown in FIG. 13. It is to be noted that the access request issued from the information terminal apparatus 1 includes a URL and a terminal identifier of its own apparatus. The contents server 101 first retrieves an entry corresponding to the URL received by the URL 203 shown in FIG. 10(a) from the advertisement control information table 105 (Step S51). If the corresponding entry is absent (YES in Step S52), the contents corresponding to the received URL are read from the contents storage element 103 or the advertisement contents storage element 104 and transmits it to the access request originator via the contents transmission element 108 (Step S53). The current processing is then terminated. As a result, the contents corresponding to an article to which no advertisement is added or the advertisement contents of the URL provided by the advertisement conformation (3) are transmitted to the information terminal apparatus 1.

If an entry having the URL which is the same as the received URL exists in the advertisement control information table 105 (NO in Step S52), a determinant is made upon whether the advertisement conformation 204 of that entry 201 is the advertisement conformation (1) (Step S54). If it is the advertisement conformation (1), the contents corresponding to the received URL are read from the contents storage element 103 and transmitted to the access request originator through the contents transmission element 108 (Step S55). Consequently, the contents on which the advertisement contents are superimposed are transmitted to the information terminal apparatus 1. The contents server 101 then informs the accounting server 102 of the advertisement ID 211 in FIG. 10(b) included in the advertisement information 205 (Step S56) and terminates the current processing.

If the advertisement conformation is other than the advertisement conformation (1) (NO in Step S54), the current position of the information terminal apparatus 1 having access is obtained from the terminal position registration element 106 based on the terminal identifier (Step S57), and the current time is acquired from an internal clock (Step S58). Further, a URL of the advertisement contents to be provided is determined based on the advertisement determination table (Step S59). That is, one of the advertisement determination table names A and B in FIG. 10(c) is selected in accordance with the fact that the current time is the morning or afternoon, and access is then made to the selected advertisement determination table. Further, an entry having the terminal position 311 which matches to the obtained terminal position is retrieved, and a URL 312 of the advertisement contents and the advertisement ID 313 in that entry are acquired.

The contents server 101 then determines whether the advertisement conformation is (2) (Step S60). If it is the advertisement conformation (2), the contents corresponding to the received URL are read from the contents storage element 103, and the advertisement contents corresponding to the obtained URL 312 are read from the advertisement contents storage element 104. The advertisement contents are added to the contents read from the contents storage element 103 by a predetermined method to be transmitted to the access request originator through the contents transmission element 108 (Step S61). As a result, the contents having the advertisement contents added at the head, midpoint or tail thereof are transmitted to the information terminal apparatus 1. On the other hand, if it is the advertisement conformation (3) (NO in Step S60), the contents corresponding to the received URL are read from the contents storage element 103, and the URL 312 of the advertisement contents is added to the read contents to be transmitted to the access request originator through the contents transmission element 108 (Step S62). In any case, the contents server 101 then informs the accounting server 102 of the obtained advertisement ID 313 (S56) and terminates the current processing.

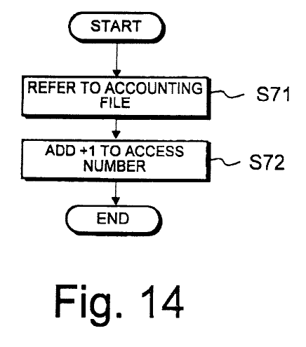

When the accounting server 102 is informed of the advertisement ID from the contents server 101, it performs the processing shown in FIG. 14. Referring to FIG. 14, the accounting file 109 having a content such as shown in FIG. 11 is first retrieved with the advertisement ID as the key, and the accounting information 403 having the same advertisement ID as the advertisement ID 411 is searched for (Step S71). The access number 415 in the accounting information 403 is incremented by +1 (Step S72).

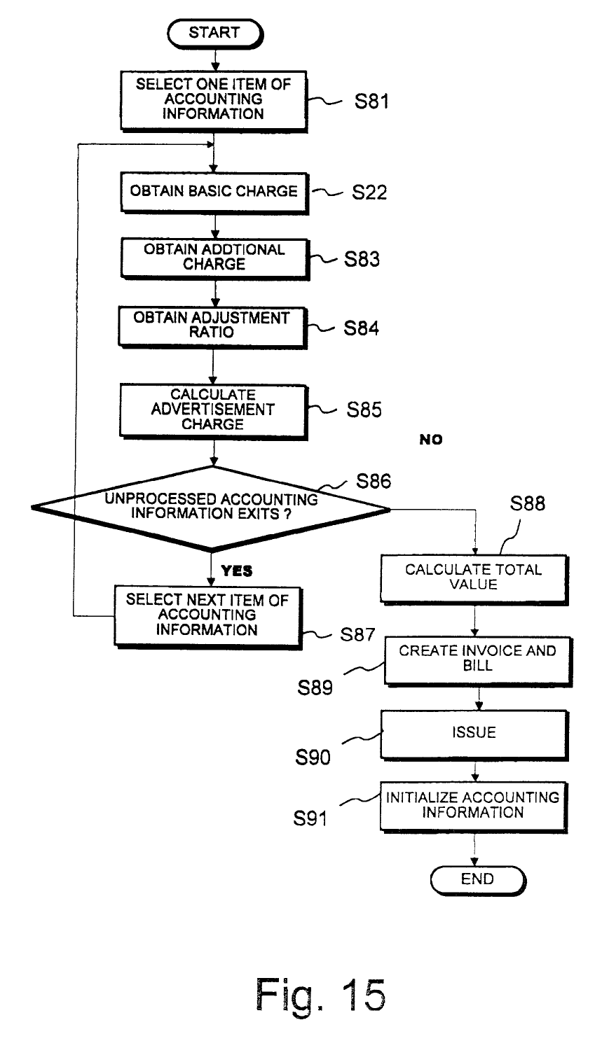

When a predetermined due date, e.g., a month end has come, the accounting server 102 calculates and charges the advertisement rate to the current advertiser by executing the processing shown in FIG. 15 in accordance with each record 401 in FIG. 11 for each advertiser stored in the accounting file 109. The accounting information 403 for one advertisement in the record 401 is selected (Step S81), and the basic charge is obtained from the article basic charge table 501 in FIG. 12(a) based on the article ID 412 (Step S82). The additional charge is then obtained from the access number charge table 531 in FIG. 12(d) based on the access number 415 (Step S83). Thereafter, the advertisement conformation adjustment ratio is obtained from the advertisement conformation charge table 511 in FIG. 12(b) based on the advertisement conformation 413. The additional charge adjustment ratio is obtained from the advertisement time zone charge table 521 in FIG. 12(c) based on the advertisement time zone 414 (Step S84). The advertisement charge for the advertisement is calculated from the following expression (Step S85), and the obtained result is temporarily set as the advertisement charge 416. Advertisement Charge=(Basic Charge+Additional Charge)×Advertisement Conformation Adjustment Ratio×Time Zone Adjustment Ratio.

If unprocessed accounting information 43 for any other advertisement remains in the record 401 (YES in Step S86), the accounting server 102 then selects the remaining one item of the accounting information 403 (Step S87), and the advertisement charge is calculated by repeating the processing which is the same as the above-described processing.

When the processing is completed with respect to all items of the accounting information 403 (NO in Step S86), a sum total of the advertisement charge 416 in each item of the accounting information 403 is calculated and set as the total charge 404 (Step S87). Thereafter, an invoice and a bill for the advertiser which are uniquely identified by the advertiser ID 402 in the record 401 are created. Contents of each item of the accounting information 403 are written on the invoice, meanwhile the advertiser ID 402, the total charge 401 and data of a biller are written on the bill. The accounting server 102 then stores the log of the invoice and the bill and transmits the invoice and the bill to the advertiser through the accounting information transmission element 111 and the communication network 80 (Step S90). The accounting server 102 initializes the record 401 (Step S91) and terminates the processing of the record 401. In initialization, the total charge 404, and the access number 415 and the advertisement charge 416 in each item of the accounting information 403 are cleared to 0, respectively.

Although differentiation of the advertisement charge according to the advertisement conformation and the advertisement time zone is represented by the adjustment ratio in the above embodiment, a table in which the basic charge is set in accordance with the advertisement conformation and the advertisement time zone may be used. Further, differentiation according to the access number was carried out using the additional charge, a table in which the basic charge is set in accordance with the access number may be used. Incidentally, if differentiation is not executed in accordance with the advertisement conformation, the advertisement time zone and the access number, the advertisement conformation adjustment table 511, the advertisement time zone adjustment table 521 and the access number adjustment table 531 are not necessary, and only the article basic charge table 501 is used.

When the information terminal apparatus 1 is used to have access to the web server on the communication network 80 through the access point of an Internet Service Provider, a communication charge or a connection charge to the provider is generated. When the newspaper publisher absorbs at least a part of this charge, the burden imposed on the reader can be lightened and it is possible to urge the reader to have aggressive access. As a method that the newspaper publisher absorbs the charge, for example, there is a method that a party to a contract of the mobile communication provider used in the information terminal apparatus 1 and a party to a contract with the Internet Service Provider are determined as the newspaper publisher and the information terminal apparatus 1 is lent to the reader at the time of the newspaper subscription contract. The newspaper publisher manages to raise the charge from, for example, the advertisement income.

A charge center of the mobile communication provider charges all or part of the communication fee imposed on the information terminal apparatus 1 to the newspaper publisher. Further, a charge center of the Internet Service Provider charges all or part of the connection fee imposed on the information terminal apparatus 1 to the newspaper publisher. When these centers are connected to the communication network 80, billing through the communication network 80 is also possible. In addition, when the mobile communication provider also serves as the Internet Service Provider, the mobile communication provider accounts and charges all or part of the communication fee or the connection fee to the newspaper publisher.

Although the newspaper and the contents on the web server are associated with each other in the system shown in FIG. 8, any other type of paper publication such as a catalogue shopping magazine and the contents on the web server can be likewise associated with each other by writing the URL on the paper publication other than the newspaper. Additionally, when the URL is written on a printed matter fixed to a building and the like (for example, a work description panel in a museum or a guide panel in a theme park) as well as a portable printed matter such as a paper publication, it is possible to easily structure the system which provides an associated moving image to a user.

According to the present invention described above, since reading access destination information written on a printed matter such as a paper publication, communication with the web server through the provider, and reading and display of the contents using the browser can be all performed in one portable apparatus, it is possible to easily make reference to the contents of the access destination information written on a printed matter anywhere.

Further, since it is possible to make reference to the contents of the access destination information written on a printed matter with ease in this manner, the information provider such as the newspaper publisher can enlarge an amount of information and improve the quality which can not be attained with paper publications alone.

While this invention has been described in conjunction with the preferred embodiments described above, it will now be possible for those skilled in the art to put this invention into practice in various other manners.

What is claimed is:

1. A portable information terminal apparatus comprising:
a display element;
a communication element;
a reading element which reads access destination information indicated on a printed matter;
a control element which connects to an access destination corresponding to said access destination information through said communication element, receives contents from said access destination, and executes a browser for displaying said received contents on said display element; and
an apparatus case which includes said display element, said reading element and said control element;
wherein a reading window for said reading element is provided on said apparatus case.

2. A portable information terminal apparatus as claimed in claim 1, wherein said reading element includes a scanner which reads an image on a printed matter through said reading window, and an extraction element which extracts said access destination information included in said image.

3. A portable information terminal apparatus as claimed in claim 1, wherein said access destination information is a URL noted on a printed matter.

4. A portable information terminal apparatus as claimed in claim 1, wherein said printed matter is a paper publication having a URL of contents containing a moving image associated with an article constituted by characters or a still image printed within or in the vicinity of said article.

5. A portable information terminal apparatus as claimed in claim 4, wherein said contents include advertisement information.

6. An information provision method comprising:
storing contents containing a moving image and being associated with an article constituted by characters or a still picture on a paper publication, which has contents locating information indicating a location of said contents and being printed within or in the vicinity of said article, in a server on a communication network;
reading said contents locating information on said paper publication by a portable information terminal apparatus; and
displaying said contents corresponding to said contents locating information on a display of said portable information terminal apparatus accessing said server and acquiring said contents based on said contents locating information.

7. An information provision method as claimed in claim 6, wherein said contents include advertisement information.

8. The information provision method as claimed in claim 6, wherein an accounting server having a charge table in which an article having advertisement information added thereto and an advertisement charge previously set based on a content of said article are registered in association with each other and an accounting file for holding accounting information for each advertiser is used so that an advertisement charge to be collected by an issuer of a paper publication from an advertiser is differentiated and imposed in accordance with an article to which said advertisement information is added.

9. The information provision method as claimed in claim 6, wherein an accounting server having a charge table in which an access number and advertisement charge information corresponding to said access number are registered in association with each other and an accounting file for holding accounting information for each advertiser is used so that an advertisement charge to be collected by an issuer of a paper publisher from an advertiser is differentiated and imposed in accordance with said access number of said advertisement information.

10. The information provision method as claimed in claim 6, wherein an accounting server having a charge table in which an advertisement time zone and advertisement charge information according to said advertisement time zone are registered in association with each other and an accounting file for holding accounting information for each advertiser is used so that an advertisement charge to be collected by an issuer of a paper publication is differentiated and imposed in accordance with said advertisement time zone for providing said advertisement information.

11. The information provision method as claimed in claim 6, wherein an accounting server having a charge table in which a conformation for providing advertisement information and advertisement charge information according to said conformation are registered in association with each other and an accounting file for holding accounting information for each advertiser is used so that an advertisement charge to be collected by an issuer of a paper publication from an advertiser is differentiated and imposed in accordance with said conformation for providing said advertisement information.

12. The information provision method as claimed in claim 6, wherein a current position of said portable information terminal apparatus having access is detected and advertisement information corresponding to said detected current position is selected to be included in contents.

13. The information provision method as claimed in claim 6, wherein at least part of a communication charge generated in said portable information terminal apparatus is imposed on an issuer of a paper publication.

14. The information provision method as claimed in claim 6, wherein at least part of a connection charge to a provider generated in said portable information terminal apparatus is imposed on an issuer of a paper publication.
